(19) United States
(12) Patent Application Publication
(10) Pub. No.: US 2006/0126846 A1
(43) Pub. Date: Jun. 15, 2006

(54) Device authentication system

(75) Inventors: Kenkichi Araki, Tokyo (JP); Hideyuki Sato, Tokyo (JP)

Correspondence Address: EDWARDS & ANGELL, LLP, P.O. BOX 55874, BOSTON, MA, 02205, US

(73) Assignees: WILLCOM, Tokyo (JP); Asia Pacific System Research Co., Ltd., Tokyo (JP)

(21) Appl. No.: 10/559,020

(22) PCT Filed: Feb. 27, 2004
(86) PCT No.: PCT/JP04/02385

§ 371 Date: Nov. 28, 2005

(30) Foreign Application Priority Data
May 30, 2003 (JP) 2003-155703

(51) Int. Cl. H04L 9/00

(52) U.S. Cl. 380/277

(57) ABSTRACT

A device authentication system comprises a terminal device, a data communications device connected to the terminal device, and a service provider. Device information stored in the terminal device is encrypted in order to produce authentication information. Transmission is carried out with respect to user information of the data communications device and the encrypted device information. The service provider decodes the encrypted device information using a device authentication server and identifies whether or not the terminal device is a terminal device suitable to service contents which is provided by the service provider, in accordance with the decoded device information. On the basis of an authentication result, the service provider determines whether or not the user information is transmitted to a user authentication server.

### TECHNICAL FIELD

The present invention relates to a system for connecting a data communications device to a terminal device to download necessary data from a data server, and more particularly, to a device authentication system for authenticating the terminal device to which the data communications device is connected.

Priority is claimed on Japanese Patent application No. 2003-155703, filed May 30, 2003, the service contents of which is incorporated herein by reference.

### BACKGROUND ART

Presently communications devices such as data communicating cards are equipped in portable terminal devices such as notebook personal computers or PDAs (Personal Data Assistants) to deliver data or to download data from a data server extensively in addition to in personal computers connected to data servers through wired networks, as the Internet has rapidly become popularized. Such systems are managed by service charge systems without regard to the kind of terminal device, inasmuch as it is impossible to distinguish the kind of terminal device which is used by the user, in data delivery.

In addition, a scheme is realized as a function individual to a specific wired or wireless network carrier in conformity with the specification of a terminal service agency, in the case of constructing a server in accordance with the request of an information service agency. For example, a scheme implemented on a Web server that identifies a network carrier of the accessor and model information of the terminal device on the Web server to convert a file originally described in the HTML file format into a certain file format which is acceptable to the terminal device accessing to the Web sever. Another scheme distinguishes a terminal device ID of the accessor on the Web server to appropriately control the access with respect to specific service contents.

However, there is a problem in that after a server which is exclusively constructed for a specific network carrier is started up, it is difficult to coordinate with other network carriers in each of these schemes.

In order to solve the above-mentioned problem, a prior art is known in which it is possible to consistently control the delivery of and access to service contents in accordance with each of the network carriers. Furthermore, it is possible to deliver appropriate service contents on the basis of the model of terminal device used by the user, as disclosed in the above-mentioned prior art.

However, there is a problem in that it is impossible to distinguish what sort of terminal device the communications device is connected to even if it is possible to identify the model of the communications device, in the case of connecting a communications device such as a data communications card to a terminal device and delivering data or carrying out downloading from a data server. In addition, a remarkable difference exists between the monthly average traffic volume based on personal computers and monthly average traffic volume based on hand-held terminal devices such as PDAs, when surveying the actual conditions among general use of communications devices. It is noted that a great difference exists between the traffic volumes on the basis of the models of the terminal devices used. Therefore, there is a problem in that it is difficult to correctly meet the desires of users inasmuch as it is impossible for a service provider to distinguish the model of the terminal device which is used by the user, although the user who uses the service by using a terminal device desires to use an appropriate fee service in accordance with the model used.

### DISCLOSURE OF THE INVENTION

The present invention proposes a device authentication system comprising a terminal device having transmission unit for transmitting device information, a data communications device connected to the terminal device, and at least one device authentication server which receives said device information and which has a device information authenticating unit for identifying whether or not the terminal device is suitable to be provided service contents, based on said device information.

According to the present invention, it is possible for a user to obtain appropriate service from a service provider, inasmuch as the transmission unit of the terminal device transmits the device information of the terminal device and the device authentication server identifies whether or not the terminal device is a terminal device which is suitable to be provided service contents, in accordance with the received device information.

The present invention proposes a device authentication system comprising a terminal device having transmission unit for transmitting device information, a data communications device connected to the terminal device, and at least one device authentication server which receives the device information and which has device information authentication unit for identifying whether or not the terminal device is suitable to be provided service contents based on the received device information. The terminal device further comprises a device information memory unit for storing the device information and authentication information production unit for encrypting the device information to produce authentication information. The device information authentication unit carries out authentication of the terminal device based on the encrypted device information.

According to the present invention, it is possible to enhance security with respect to the terminal device authentication system, inasmuch as the device information is encrypted to be transmitted to the device authentication server from the terminal device when the terminal device authentication system authenticates the terminal device.

The present invention proposes a device authentication system comprising a terminal device having transmission unit for transmitting device information, a data communications device connected to the terminal device, at least one device authentication server which receives the device information and which has a device information authentication unit for identifying whether or not the terminal device is suitable to be provided service contents based on the device information, and a key management server for producing an encryption key specific to the terminal device. The terminal device further comprises device information memory unit for storing the device information and authentication information production unit for encrypting the device information based on the encryption key specific to the terminal device to produce authentication information. The device information authentication unit carries out authentication of the device in accordance with the encrypted device information. The device information authentication unit requests the key management server to produce the encryption key when the device information does not have the encryption key specific to the terminal device, on first receiving the device information from the terminal device at the device information authentication unit. The device information authentication unit transmits the produced encryption key to the terminal device. The authentication information producing unit memorizes the transmitted encryption key therein to encrypt the device information by using the memorized encryption key from then on.

According to the present invention, the device information authentication unit produces an encryption key specific to the terminal device in a case where the received device information does not have the encryption key specific to the terminal device, when the device information authentication unit first receives the device information from the terminal device. The produced encryption key is transmitted from the device information authentication unit to the terminal device to be memorized in the terminal device. As a result, it is possible to carry out the encryption from then on even though the specific encryption key is not memorized in the terminal device in advance. Therefore, it is unnecessary to have a process for memorizing the encryption key specific to the terminal device, when manufacturing the terminal device. It is possible to reduce time and effort in the terminal device manufacturing.

In addition, the present invention proposes a device authentication system described above further comprising at least one user authentication server for authenticating a user of the data communications device. The transmission unit transmits user information maintained within the data communications device. The device authentication server comprises authentication control unit for controlling whether or not the user information is transmitted to the user authentication server in accordance with an authentication result supplied from the device information authentication unit.

According to the present invention, the device authentication server deciphers the received device information. The device information authentication unit identifies whether or not the terminal device is suitable to receive service contents which is provided by a service provider, in accordance with the deciphered device information. As a result of the authentication, the user information is transmitted to the user authentication server by the authentication control unit and an appropriate service is provided to the terminal device, when the device information authentication unit identifies that the terminal device is suitable to receive the service contents which is provided by the service provider.

Furthermore, the present invention proposes a device authentication system in which the terminal device comprises selection unit for selecting whether or not transmission is carried out with respect to the encrypted device information.

According to the present invention, it is possible to obtain appropriate service corresponding to a model used when the device information is transmitted to the service provider using the device authentication system, inasmuch as the terminal device comprises selection unit for selecting whether or not transmission is carried out with respect to the encrypted device information. In addition, it is possible to obtain a regular service from a service provider who does not adopt the device authentication system, inasmuch as the terminal device does not transmit the device information.

The present invention proposes a device authentication system in which the device information has a device identification number specific to the terminal device.

According to the present invention, it is possible to accurately identify the terminal device used using the device identification number specific to the terminal device, inasmuch as the device information has a serial number of the terminal device. Therefore, it is possible to specify whether or not the terminal device has been given to staff or which staff the terminal device has been given to, using the device information and the serial number, in a case where an enterprise gives terminal devices to staff. As a result, it is possible to improve security without using a one time password or an IC card when using the above-mentioned information, in the case of connecting terminal devices to a LAN of the enterprise.

The present invention proposes a device authentication system in which the device authentication server transmits a confirmation message to the terminal device when the device authentication server does not receive the device authentication information from the terminal device.

According to the present invention, it is possible for the user using the system to obtain service which the user desires, when the user carries out an appropriate operation manually in accordance with the confirmation message, inasmuch as the device authentication server transmits the confirmation message to the terminal device when the device authentication server does not receive the device authentication information from the terminal device.

In addition, the present invention proposes a terminal device further comprising a message control unit for retransmitting the device authentication information to the device authentication server when the terminal device receives the confirmation message from the device authentication server.

According to the present invention, it is possible for the user to obtain appropriate service even if the user does not carry out a specific operation, inasmuch as the message control unit again transmits the device authentication information to the device authentication server when the terminal device receives the confirmation message from the device authentication server.

The present invention proposes a device authentication system in which a terminal device comprises an operating system and connection monitoring unit for monitoring whether or not an external device is connected to the terminal device. The connection monitoring unit disconnects cut off an interconnection between the external device and the terminal device when the connection monitoring unit detects that the external device is connected to the terminal device on the basis of information on the operating system.

According to the present invention, it is possible to effectively prevent an illegitimate action in which data are downloaded by a personal computer or the like, through a terminal device such as a PDA, inasmuch as the connection monitoring unit disconnects an interconnection between the external device and the terminal device when an external device other than the data communications device is connected to the terminal device.

The present invention proposes a device authentication system in which device authentication is carried out over Point to Point protocol (PPP) link layer.

### BRIEF DESCRIPTION OF THE DRAWINGS

FIG. 1 shows a configuration of a device authentication system according to a first embodiment of the present invention.

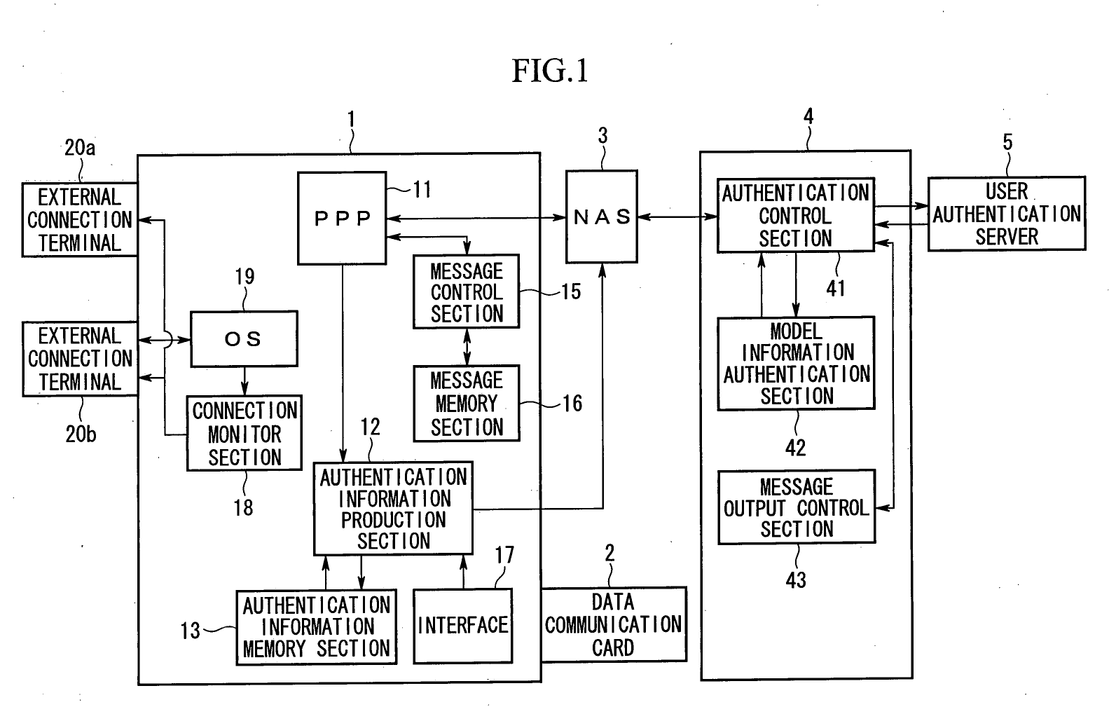

FIG. 2 shows a configuration of a PDA used in the first embodiment of the present invention.

FIG. 3 shows a configuration of an authentication control section illustrated in FIG. 1.

FIG. 4 shows a configuration of a device information authentication section illustrated in FIG. 1.

FIG. 5 is a flowchart for describing a process of the device authentication system illustrated in FIG. 1.

FIG. 6 shows a configuration of an device authentication system according to a second embodiment of the present invention.

### BEST MODE FOR CARRYING OUT THE INVENTION

A description will be made of preferred embodiments of the present invention with reference to drawings hereinafter. Incidentally, the present invention is not limited to the embodiments described hereinafter. For example, the components between the embodiments may be appropriately combined.

A device authentication system according to a first embodiment of the present invention comprises a PDA (terminal device) 1, a data communications card 2, an NAS (Network Access Server) 3, a device authentication server 4, and a user authentication server 5.

The PDA 1 is a hand-held terminal device used by a user who requests service such as data delivery or downloading. The data communications card 2 is a card type communications device having a data communicating function. The NAS 3 is a server which carries out access to a network such as the Internet in accordance with a request from the terminal device, to carry out routing to an appropriate server. The NAS 3 is connected to the PDA 1 over a PPP (Point to Point Protocol) link layer.

The device authentication server 4 is a server for receiving, through the NAS 3, device information of the PDA 1 in which the data communications card 2 is equipped. The user authentication server 5 is a server for authenticating the user of the PDA 1 in accordance with an user ID of and a password which are maintained within the data communication card 2. When the device authentication server 4 and the user authentication server 5 authenticate the PDA 1 and the user of the PDA 1, respectively, it is possible for such user to access a site or a server which the user wants to access by using the PDA 1.

The PDA 1 comprises a PPP 11, an authentication information production section 12, an authentication information memory section 13, a message control section 15, a message memory section 16, a connection monitoring section 18, an operating system (OS) 19, external connection terminals 20a and 20b, a operation input section having input buttons, a display section for displaying character information and image data, and a control section for controlling the PDA 11. No illustration is made as regards each of the operation input section, the display section, and the control section. In addition, a slot is formed on a part of PDA 1. The data communications card 2 is inserted into the slot. When the data communications card 2 is inserted into the slot, the data communications card 2 is electrically connected to the PDA 1. The PPP 11 is one method of connecting the terminal device to the Internet by dial-up, using a physical layer and/or a data link layer for carrying out communications using a communications line such as a telephone line, namely, a serial line. The PPP 11 is different from Serial Line Internet Protocol (SLIP) and has a characteristic in which it is possible to support Transmission Control Protocol (TCP)/Internet Protocol (IP), Internet Packet Exchange (IPX), and other protocols as well. Furthermore, the PPP 11 is a flexible protocol allowing reconnection based on a link status, i.e., status of the modem and line used, automatic negotiation of IP addresses used in both end terminals, an authentication function, and a compression function.

In the present invention, Chap Response is transmitted to the NAS 3 by dial-up in order to establish communication. Furthermore, encrypted user information and device information are produced as a series of data sequences which are transmitted to the NAS 3. The authentication information memory section 13 is a memory device in which the device information such as model information and a serial number of the terminal device is stored. The authentication information memory section 13 is constructed as an un-rewritable memory device or a write-once memory device such as ROM (Read Only Memory).

The connection monitoring section 18 judges whether or not an external device, other than the data communications card 2, is connected to the PDA 1 through an external connection terminal 20a or 20b such as an IrDA (Infrared Data Association) or a USB. More specifically, the connection monitoring section 18 detects such external device connected to the PDA 1 through the external connection terminal 201 or 20b by referring to a specific data area allocated by the OS 19 in which the information of the connected external device is described. Alternatively, the connection monitoring section 18 may detect and identify such external device by specifying the external connection terminals 20a and 20b on which the external device establishes an outgoing session through the PDA 1 equipped with the data communications card 2, with reference to process information in the OS 19. Furthermore, the connection monitoring section 18 may detects and identify such external device by retrieving the ports used with reference to an IP address used in the OS 19. In addition, the connection monitoring section 18 may output a message which instructs the connected external device to cut or finish off the outgoing session or PPP communication, in order to disconnect such outgoing session or PPP communication implemented by such external device, in a case where the external device is connected to the PDA 1 through the external connection terminal 20a or 20b. Incidentally, the connection monitoring section 18 may disconnect the communication between the PDA 1 and the data server, in a case where an external device is connected to the PDA 1 through the external connection terminal 20a or 20b.

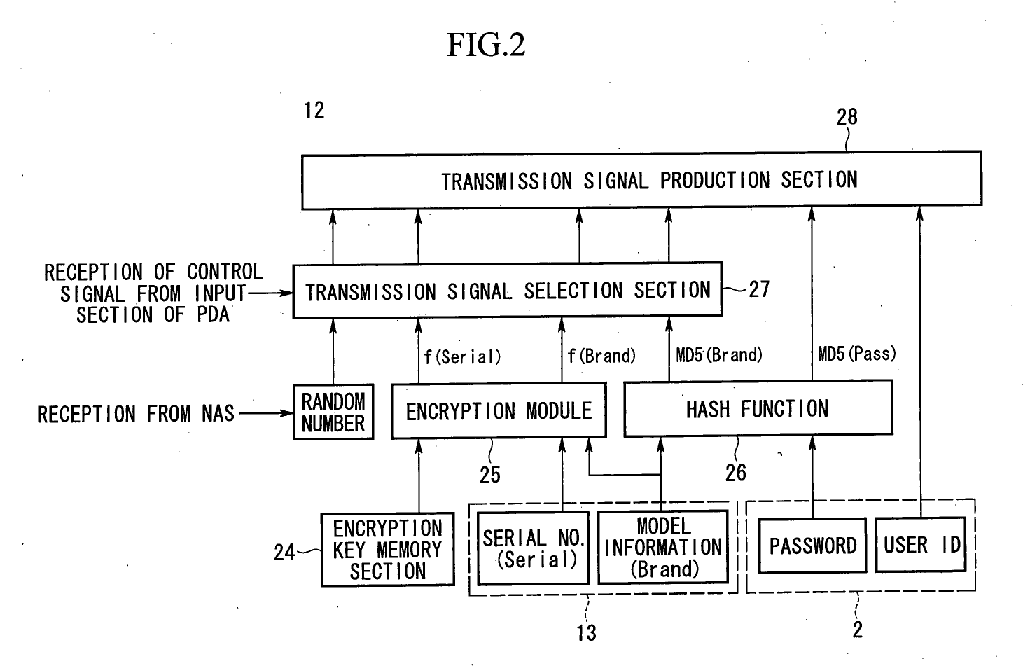

As shown in FIG. 2, the authentication information production section 12 comprises an encryption key memory section 24, an encryption module 25, a hash function 26, a transmission signal selecting section 27, and a transmission signal production section 28. The encryption key memory section 24 is for memorizing encryption keys which are for use in encrypting the model information (Brand) and serial number (Serial), those of which are stored in the authentication information memory section 13. Incidentally, encryption keys are provided which are different from one another for different models. The user of the terminal device is not informed of the inventory location for the encryption keys in order to enhance security. In addition, the encryption keys are stored in an un-rewritable memory device or a write-once memory device such as ROM, in order to prevent the encryption keys from being rewritten.

The encryption module 25 is for encrypting the model information and the serial number. More specifically, the encryption module 25 takes the encryption key which is stored in the encryption key memory section 24, and encrypts the model information and the serial number by using the taken encryption key. The model information (Brand) and the serial number (Serial), each of which is encrypted, are outputted as f (Brand) and f (Serial) to the transmission signal selection section 27.

The hash function 26 is an arithmetical one-way function for encrypting the model information and the password. Using the hash function 26, it is possible to obtain an one-way hashed output with respect to a given input. The model information (Brand) and the password (Pass) are encrypted into, for example, MD 5 (Brand) and MD 5 (Pass) by the hash function 26, to be outputted to the transmission signal selection section 27. The transmission signal selection section 27 determines whether or not the model information is added to the signal to be transmitted to the NAS 3, in accordance with a control signal corresponding to the user's instruction made by input buttons of the PDA 1. Incidentally, the device information collectively represents the model information, the serial number, or the performance of the terminal device that is typically represented by the information concerning a terminal device such as a browser, a CPU, or an HDD, incorporated into the terminal device, for example.

In addition, the transmission signal production section 28 produces a transmission signal to be transmitted to the NAS 3, on the basis of the information supplied by the transmission signal selection section 27 or the data communications card 2. More particularly, the transmission signal production section 28 combines the encrypted model information f(Brand) and the encrypted serial number f(Serial) (f(Brand) and f(Serial)) supplied by the transmission signal selection section 27, the information (MD 5 (Brand) and MD 5 (Pass)) obtained by encrypting the model information and the password using the hash function 26, and random numbers supplied by the NAS 3, or information such as the user ID supplied by the data communications card 2, to produce data sequence which is outputted to the NAS 3.

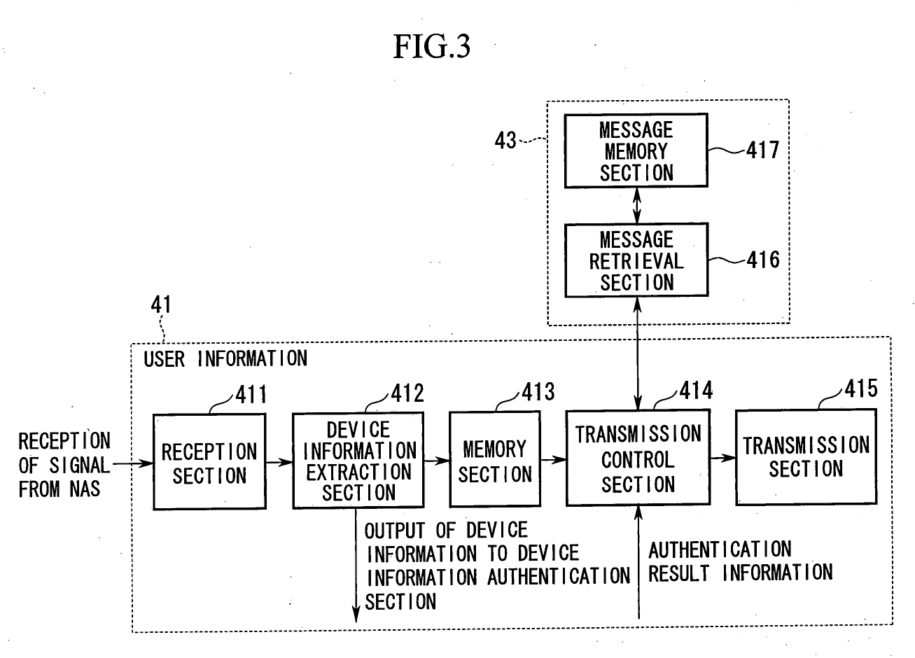

The device authentication server 4 comprises an authentication control section 41, a device information authentication section 42, a message output control section 43, a communications section for transmitting and receiving data between the device authentication server 4 and the NAS 3, and a communications section for transmitting and receiving between the device authentication server 4 and the user authentication server 5. No illustration is made as regards each of the communications sections. As shown in FIG. 3, the authentication control section 41 comprises a reception section 411, a device information extraction section 412, a memory section 413, a transmission control section 414, a transmission section 415, a message retrieval section 416, and a message memory section 417. Incidentally, the reception section 411 is communicating unit for receiving the information from the NAS 3. The transmission section 415 is communicating unit for transmitting the information to the user authentication server 5.

The device information extraction section 412 extracts the information concerning the device authentication and the user authentication, from the information inputted through the reception section 411. The model information extraction section 412 separates the information concerning the device authentication and the information concerning the user authentication from the aforementioned extracted information. The device information extraction section 412 then outputs the separated device information to the device information authentication section 42 and also outputs the separated user information to the memory section 413. The memory section 413 is a memory device for temporally buffering the separated user information until an authentication result is provided by the device information authentication section 42. The memory section 413 is composed of a rewritable RAM (Random Access Memory) or the like.

The transmission control section 414 controls whether or not the user information to be informed to the transmission section, based on the authentication result supplied from the device information authentication section 42. More particularly, the transmission control section 414 reads the user information out of the memory section 413 and outputs the read out user information to the transmission section 415, when the model authentication section 42 supplies the transmission control section 414 with an authentication result signal indicating a success of authentication with respect to the device information received from NAS 3. When the model authentication section 42 supplies the transmission control section 414 with an authentication result signal which indicates a fault in the authentication process implemented by the model authentication section 42, the transmission control section 414 does not output the read out user information to the transmission section 415, but outputs such model authentication fault signal to the message output control section 43. When the message retrieval section 416 detects no device information to authenticate is included in the information received from the terminal device, on the basis of the authentication result information supplied by the device information authentication section 42, the message retrieval section 416 provides the massage memory section 417 with a signal indicating a lack of the device information to authenticate and retrieves message data corresponding to the lack of device information to authenticate, from the message memory section 417, and outputs the retrieved message data to the transmission control section 414.

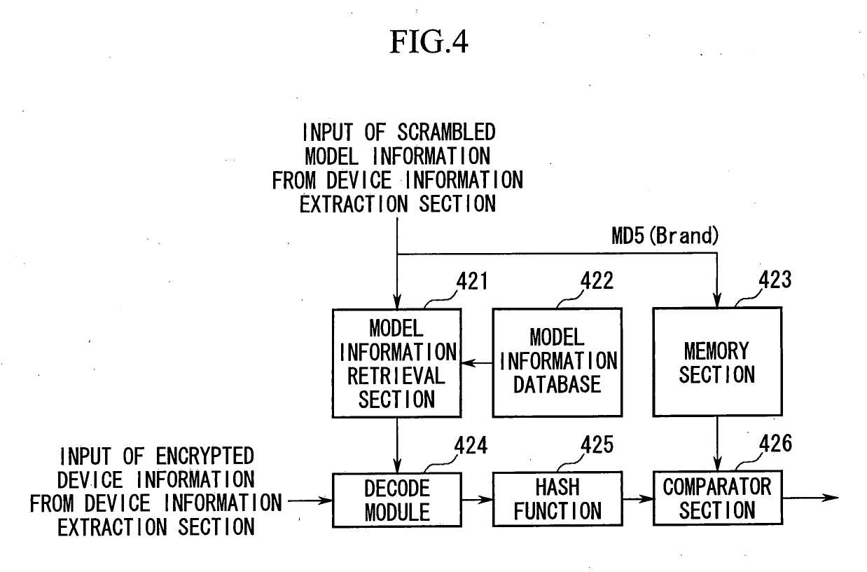

As shown in FIG. 4, the device information authentication section 42 comprises a model information retrieval section 421, a model information database 422, a memory section 423, a decoding module 424, a hash function 425, and a comparator section 426. The model information retrieval section 421 accepts the model information (MD 5 (Brand)) which is hashed by the one-way hash function, from the device information extraction section 412. The model information retrieval section 421 retrieves the encryption key corresponding to the accepted model information, from the model information database 422. The model information database 422 is a database for memorizing the hashed model information (MD 5 (Brand)) and the encryption keys corresponding to the model information. The model database 422 is stored in an un-rewritable memory device or a write-once memory device such as ROM.

The memory section 423 is a memory device for temporally buffering the hashed model information (MD 5 (Brand)) and is composed of a rewritable memory device such as RAM. The decoding module 424 is a module for deciphering the model information encrypted in accordance with the encryption key. More specifically, the decoding module 424 takes the encryption key from the model information retrieval section 421 and deciphers the encrypted model information by using the encryption key. Similarly, the serial number of the terminal device is also deciphered in accordance with the encryption key which is taken from the model information database 422. Thus, a service provider is able to provide each PDA user with appropriate service contents corresponding to each PDA on the basis of the deciphered serial number.

The deciphered model information is then calculated using the hash function 425, and conveys the hashed model information to the comparator section 426. The comparator section 426 is supplied with both of the hashed model information came from the memory section 423 and the hashed model information calculated by the hash function 425 after deciphering. The comparator section 426 identifies whether or not the two sets of the hashed model information coincide with each other. The comparison result provided by the comparator section 426 is outputted as an authentication result to the authentication control section 41. The message control section 43 outputs the message data retrieved from the message memory section 417 by the message retrieval section 416, to the communications section of the device authentication server 4 that is not illustrated, in accordance with the output of the authentication control section 41.

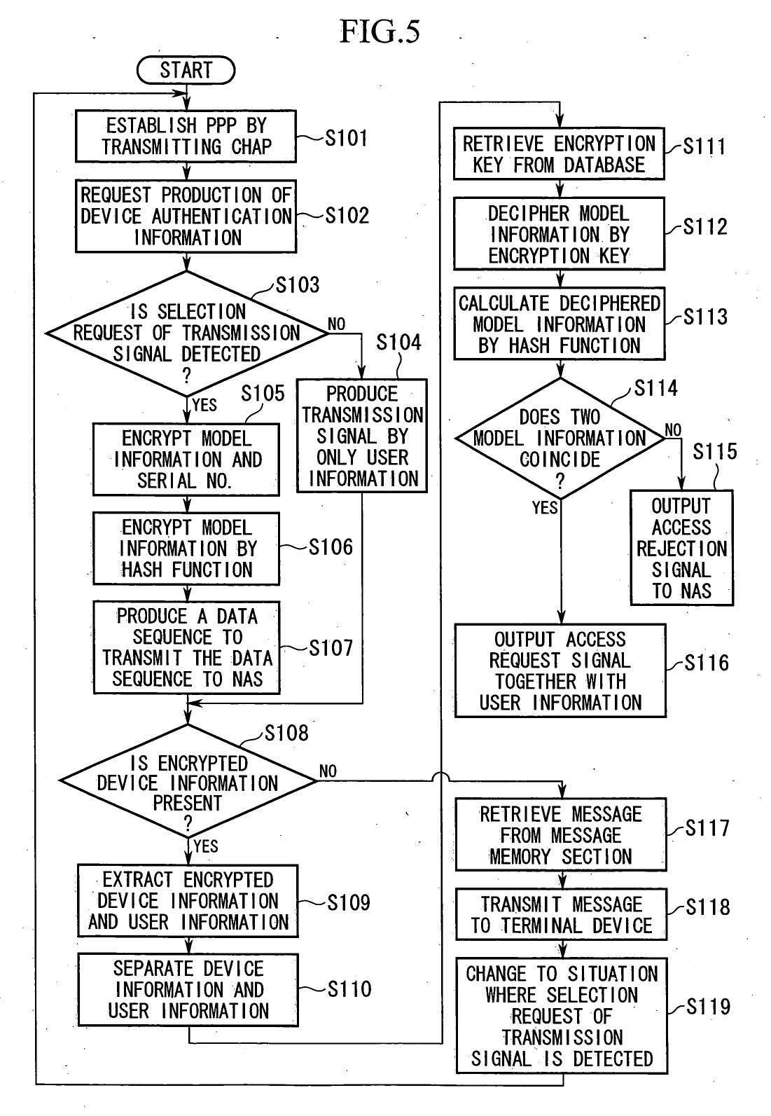

Next, description will proceed to a processing procedure of the device authentication system according to the present embodiment, with reference to FIG. 5.

First, the data communications card 2 is inserted into the slot of the PDA 1 and user authentication is requested of a service provider by using an Internet connection tool, in order that the user of the PDA 1 may carry out data delivery or data downloading through the service provider. As a result, the PPP 11 operates and transmits a Chap Response to the NAS 3, in order to establish PPP communication between the PDA 1 and the NAS 3 at step 101. The PPP 11 of the PDA 1 requests the authentication production section 12 to produce the device authentication information at step 102.

When the authentication information production section 12 receives the signal requesting the production of device authentication information from the PPP 11, the authentication information production section 12 identifies whether or not an input section of the PDA 1 feeds the transmission signal selection section 27 with a selection request signal for selecting a transmission signal, at step 103. When the authentication information production section 12 identifies that the selection request signal is applied to the transmission signal selection section 27, the authentication information production section 12 produces data sequence solely using the encrypted password and user ID, those of which are originated from the data communications 2 and supplied to the transmission signal production section 28, at step 104.

In the case that the input section of the PDA 1 does not feed the selection request signal, the encryption module 25 acquires the encryption key corresponding to the PDA 1 from the encryption key memory section 24, and encrypts the model information (Brand) and the serial number (Serial) to produce f (Brand) and f (Serial) at step 105. Furthermore, the encryption module 25 encrypts the model information (Brand) using the hash function 26 to produce MD 5 (Brand) at step 106. The transmission signal production section 28 combines each information of f (Brand), f (Serial), MD 5 (Brand), and the user information, and a random number received from the NAS 3, respectively, to produce data sequence which is transmitted to the NAS 3 through the PPP 11, at step 107.

The NAS 3 routes user's access information to the service provider designated by the user of the PDA 1. The NAS 3 outputs the information composed of the encrypted data sequence to the device authentication server 4. The information transmitted by the NAS 3 is received by the reception section 411 of the authentication control section 41 which is installed in the device authentication server 4, and is delivered to the device information extraction section 412. The device information extraction section 412 identifies whether or not the information has the encrypted model information at step 108. When the device information extraction section 412 identifies that the inputted information has the encrypted model information, the device information extraction section 412 extracts the information concerning the device authentication and the user authentication, from the inputted information, at step 109. The extracted information is separated by the device information extraction section 412 to the information concerning the device authentication and the information concerning the user authentication, respectively. The device information is outputted to the device information authentication section 42 and the user information is outputted to the memory section 413 at step 110.

When the device information extraction section 412 identifies that the inputted information does not include the encrypted model information, the message retrieval section 416 retrieves the message corresponding to the lack of the encrypted model information from the message memory section 417 at step 117. The retrieved message is transmitted to the PDA 1 at step 118. This message received from the device authentication server 4 is outputted to the message control section 15 of the PDA 1. The message control section 15 checks the inputted message data with the data stored in the message memory section 16 and outputs the corresponding display data to a display section which is not illustrated. Furthermore, the message control section 15 puts a transmission selection button, which is not illustrated, into an ON state and transmits CHAP to establish PPP at step 101, in order to again challenge to transmit the device authentication information to the device authentication server 4.

In the device information inputted to the device information authentication section 42, the hashed model information (MD 5 (Brand)) is inputted to the model information retrieval section 421 of the device information authentication section 42. The model information retrieval section 421 retrieves the encryption key corresponding to the hashed model information, from the model information database 422 at step 111. The decoding module 424 is supplied with the encrypted model information from the device information extraction section 412 and deciphers the encrypted model information using an encryption key which is acquired from the model information retrieval section 421, at step 112. The deciphered model information is calculated by the hash function to be outputted to the comparator section 426 at step 113. Through the memory section 423, the comparator section 426 is also supplied with another model information (MD 5 (Brand)) which is calculated by the hash function 425. The comparator section 426 identifies whether or not the two sets of the model information coincide with each other at step 114.

The authentication control section 41 is supplied with the authentication result from the device information authentication section 42. When the terminal device is successfully authenticated at the device authentication sever 4, the authentication control section 414 cause the transmission section 415 to transmit together the user information, which is temporally stored in the memory section 413, and an access request signal to the user authentication server 5 at step 116. The user authentication server 5 carries out the user authentication in accordance with the user information informed from the device authentication server 4. After the user authentication server 5 finishes its authentication task, the user authentication server 5 accesses a site which the user wants to access.

On the other hand, when the terminal device is not successfully authorized, the device authentication server 4 transmits an access rejection signal to the NAS 3 through the transmission section 415. Responsive to the access rejection signal, the NAS 3 transmits a fault signal representative of access failure, to the PDA 1. The PDA 1 displays the access failure on the display section in order to inform the terminal device user of the access failure, at step 115.

Incidentally, the information representative of the serial number, which is uniquely attached to and transmitted from the terminal device, is deciphered using the encryption key for deciphering the model information and the deciphered serial number stored in a memory equipped within the device authentication server 4. Inasmuch as it is possible to accurately identify the user of the terminal device by using the deciphered serial number together with the deciphered model information, it is possible to provide various services when using the above-mentioned information.

According to the present embodiment, a challenging terminal device transmits the hashed model information MD5 (Brand) and the key-encrypted model information f(Brand) to authentication server 4 through NAS 3. The authentication server 4 deciphers the key-encrypted model information f(Brand) by using the encryption key stored within the device authentication server 4 itself. The deciphered model information is further hashed and compared with the hashed model information MD5 (Brand). Therefore, it is possible to authenticate the terminal device to which the data communications card is connected based on a comparison result between the two hashed model information. As a result it is possible to provide various network communication services to the terminal device user.

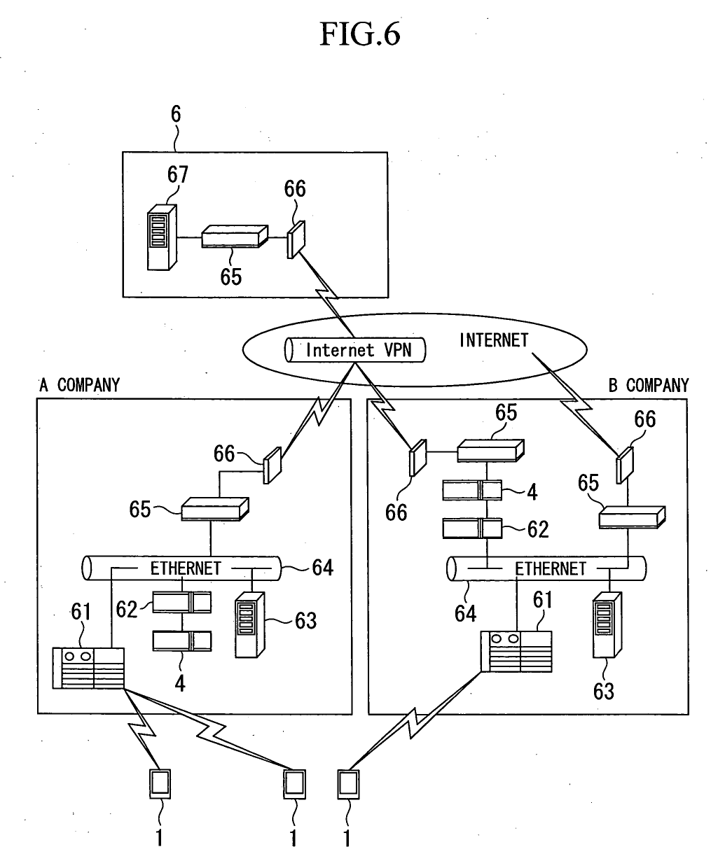

Next, description will proceed to a second embodiment of the present invention, with reference to FIG. 6.

As shown in FIG. 6, the device authentication system according to the second embodiment of the present invention comprises an encryption key download center in addition to the system of the first embodiment.

More particularly, the illustrated system comprises the PDA 1 which is the user terminal device, device authentication servers 4 which a network carrier company A and a network carrier company B own, respectively, and an encryption key download center 6 which is connected to the device authentication servers 4 through the Internet.

The systems which company A and company B own each comprise an LNS (L2TP Network server) 61, Radius Proxy 62, a device authentication server 4, an Ethernet 64, a router 65, and a fire wall 66.

In addition, the encryption key download center 6 comprises a key management server 67, a router 65, and a fire wall 66.

Description will be made as regards operation of the present system. First, the user terminal device (PDA) 1 requests the authentication of device information of the device authentication sever 4 of company A or company B through the LNS 51 and the Ethernet 64. At that time, the device authentication server 4 identifies whether or not the transmitted device information has the encryption key. When the transmitted device information does not have the encryption key according to the result of judgment, the device authentication server 4 requests the encryption key download center 6 to produce the encryption key specific to the user terminal device 1, through the Internet.

When receiving an encryption key production request from the device authentication server 4, the key management server 67 produces the encryption key specific to the user terminal device 1, and then transmits the produced encryption key specific to the user terminal device 1 to the request device authentication sever 4. The device authentication server 4 receives the encryption key and transmits the encryption key to the user terminal device 1. The user terminal device 1 receives the encryption key to store the encryption key in the encryption key memory section 24. After that, the user terminal device 1 encrypts the device information by using the encryption key stored in the encryption key memory section 24, when carrying out device authentication request.

According to the present embodiment, it is possible to get the encryption key specific to the user terminal device, from the encryption key download center through the Internet during primary device authentication request, even if the encryption key specific to the user terminal device is not stored in the user terminal device in a manufacturing process.

Although detailed descriptions are made as regards the embodiments of the present invention with reference to drawings, concrete configurations are not limited to the above-mentioned embodiments. It is possible to carry out design changes without going out of scope of the sprit of the present invention. For example, the terminal device is not limited to a PDA, although a description is made about the PDA as an example of the terminal device in each of the above-mentioned embodiments. The terminal device may be, for example, a mobile phone, a personal handy phone, a notebook personal computer, or the like.

In addition, it is possible to use the present system in other electronic devices or electric appliances which have device authenticating software, if the electronic device or electric appliance has a function in which it is possible for it to be connected to the data communications card and to be connected to a network.

Furthermore, the authentication may be carried out at a stage of IP communication, although description is made about an example in which the authentication is carried out at a stage of PPP communication, in each of the present embodiments. Although description is made as regards whether or not encrypted device information is transmitted to the device authentication server with respect to means for selecting whether or not the device authentication is used, in each of the present embodiments, a configuration may be used in which the device information is not encrypted.

In addition, it is possible to use any system without being limited to the hash function described in each of the embodiments, when ensuring a security of the system, although a description is made about encrypting the information in each of the present embodiments. In this case, it is necessary for the device authentication server to have a decoding module.

### INDUSTRIAL APPLICABILITY

According to the present invention, there is an effect in which it is possible to construct a system which carries out authentication of a terminal device with a simple configuration, by adding the device authentication server and installing software necessary for device authentication in the terminal device, without changing the NAS and the user authentication server. In addition, there is an effect in which it is possible to construct a device authentication system which is capable of providing appropriate service corresponding to each model, by distinguishing the model used by the user who uses a service such as data delivery.

Furthermore, there is an effect in which flexibility is secured when a terminal device user selects one of the service providers, inasmuch as the device authentication system has selecting means for selecting whether or not the user carries out device authentication. In addition, it is possible to accurately identify the user of the terminal device inasmuch as the device information of the terminal device is used as the serial number. As a result, there is an effect in which it is possible to provide a service specific to the terminal device user.

1. A device authentication system comprising:
a terminal device having a transmission unit for transmitting device information;
a data communications device connected to said terminal device; and
at least one device authentication server which receives said device information and which has a device information authenticating unit for identifying whether or not said terminal device is suitable to be provided service contents, based on said device information.

2. A device authentication system comprising:
a terminal device having a transmission unit for transmitting device information;
a data communications device connected to said terminal device; and
at least one device authentication server which receives said device information and which has a device information authentication unit for identifying whether or not said terminal device is suitable to be provided service contents based on the received device information;
said terminal device comprising:
a device information memory unit for storing said device information; and
an authentication information production unit for encrypting said device information to produce authentication information,
wherein said device information authentication unit carries out authentication of said terminal device based on the encrypted device information.

3. A device authentication system comprising:
a terminal device having a transmission unit for transmitting device information;
a data communications device connected to said terminal device;
at least one device authentication server which receives said device information and which has a device information authentication unit for identifying whether or not said terminal device is suitable to be provided service contents, based on said device information; and
a key management server for producing an encryption key specific to said terminal device;
said terminal device comprising:
a device information memory unit for storing said device information; and
an authentication information production unit for encrypting said device information based on said encryption key specific to said terminal device to produce authentication information,
wherein said device information authentication unit carries out authentication of the device in accordance with the encrypted device information;
said device information authentication unit requests said key management server to produce the encryption key when said device information does not have the encryption key specific to said terminal device, on first receiving said device information from said terminal device at said device information authentication unit; and
said device information authentication unit transmits the produced encryption key to said terminal device; and
wherein said authentication information production unit memorizes the transmitted encryption key therein to encrypt said device information by using the memorized encryption key from then on.

4. A device authentication system as claimed in any one of claims 1 to 3, wherein:
said device authentication system further comprises at least one user authentication server for authenticating a user of said data communications device;
said transmission unit transmits user information of said data communications device; and
said device authentication server comprises an authentication control unit for controlling whether or not said user information is transmitted to said user authentication server in accordance with an authentication result supplied from said device information authentication unit.

5. A device authentication system as claimed in claim 2 or 3, wherein said terminal device comprises a selection unit for selecting whether or not transmission is carried out with respect to said encrypted device information.

6. A device authentication system as claimed in any one of claims 1 to 3, wherein said device information has a device identification number specific to said terminal device.

7. A device authentication system as claimed in any one of claims 1 to 3, wherein said device authentication server transmits a confirmation message to said terminal device when said device authentication server does not receive the device authentication information from said terminal device.

8. A device authentication system as claimed in any one of claims 1 to 3, wherein said terminal device further comprising a message control unit for retransmitting said device authentication information to said device authentication server when said terminal device receives said confirmation message from said device authentication server.

9. A device authentication system as claimed in any one of claims 1 to 3, wherein:
said terminal device comprises:
an operating system; and
a connection monitoring unit for monitoring whether or not an external device is connected to said terminal device,
wherein said connection monitoring unit disconnects an interconnection between said external device and said terminal device when said connection monitoring unit detects that said external device is connected to said terminal device on the basis of information in said operating system.

10. A device authentication system as claimed in any one of claims 1 to 3, wherein:
said terminal device comprises:
an operating system; and
a connection monitoring unit for monitoring whether or not an external device is connected to said terminal device,
wherein said connection monitoring unit disconnects communication between said data communications device and a data server when said connection monitoring unit detects that said external device is connected to said terminal device on the basis of information in said operating system.

11. A device authentication system as claimed in any one of claims 1 to 3, wherein device authentication is carried out by Point to Point Protocol (PPP) in said device authentication unit.
